(19) United States
(12) Patent Application Publication
(10) Pub. No.: US 2005/0285287 A1
(43) Pub. Date: Dec. 29, 2005

(54) Injection mold and method for molding an optical element

(75) Inventors: Yoshihiro Okumura, Toyohashi-shi (JP); Atsushi Naito, Aichi-ken (JP); Kanji Sekihara, Toyokawa-shi (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 11/167,968

(22) Filed: Jun. 28, 2005

(30) Foreign Application Priority Data
Jun. 29, 2004 (JP) 2004-191837PAT

(51) Int. Cl. B29D 11/00

(52) U.S. Cl. 264/2.5; 249/134; 249/111; 425/542; 249/135

(57) ABSTRACT

An injection mold composed of a movable mold and a fixed mold. The movable mold has bases, a heat insulating layer and a surface processed layer, and the fixed mold has a base. A heat insulator is provided on the inner circumferential surface of the base of the movable mold at a part forming a wall of a cavity. The heat insulating layer is in the rear of the surface processed layer, and therefore, the transfer accuracy of a fine configuration of the surface processed layer is improved. Additionally, since the heat insulator is provided adjacent to the fine configuration, heat radiation from resin is inhibited, and the transfer accuracy of the fine configuration is further improved.

This application is based on Japanese Patent Application No. 2004-191837 filed on Jun. 29, 2004, the content of which is herein incorporated by reference.

### BACKGROUND OF THE INVENTION

1. Field of the Invention

The present invention relates to an injection mold and a method for molding an optical element, and more particularly to an injection mold for molding a small and light optical element, such as a lens, an optical waveguide, etc., and a method for molding an optical element.

2. Description of Related Art

In recent years, with improvement of resin materials and injection molding techniques, various kinds of small and light lenses, prism plates and optical waveguides have been developed, and a demand for use of these optical elements for optical pick-up devices and portable telephones has been stronger. In order to produce such optical elements, molds which permit accurate transfer of fine configurations for diffraction, fine configurations for prism surfaces, blaze surfaces, etc. and smooth surfaces are required.

In order to achieve high accuracy transfer, Japanese Patent Laid-Open Publication No. 2002-96335 suggests a mold 50 as shown by FIG. 7. The mold 50 has a heat insulating layer 53 between a core base 52 located in the center of a mold base 51 and a surface processed layer 54. A cavity 60 is formed between the surface processed layer 54 with a blaze surface 54a, which is of a fine configuration, and a mold base 55. The heat insulating layer 53 is preferably a ceramic flame coating, and the surface processed layer 54 is preferably a nickel plating.

Since the mold 50 has a heat insulating layer 53 in the rear of the fine configuration (blaze surface 54a), the heat retaining property of the blaze surface 54a is improved, and it is possible to transfer the fine configuration to a molded product at high accuracy. However, at an area 51a next to the blaze surface 54a, the mold base 51, which has a relatively high coefficient of thermal conductivity, is exposed. Therefore, in this area 51a, heat radiation from melted resin injected into the cavity 60 is large, and it has been found that this influences the transfer accuracy of the fine configuration.

### SUMMARY OF THE INVENTION

An object of the present invention is to provide an injection mold and an optical element molding method which permit a further improvement in transfer accuracy of a fine configuration.

In order to achieve the object, a first aspect of the present invention provides an injection mold for molding an optical element out of resin comprising a heat insulating layer between a core base and a surface processed layer, wherein a mold base forming a cavity to be filled with resin comprises at least a part made of a heat insulating material, the part being adjacent to the surface processed layer.

The second aspect of the present invention provides a method for injection molding an optical element out of resin by use of an injection mold comprising at least a movable mold and a fixed mold, wherein the injection mold comprises a heat insulating layer between a core base and a surface processed layer, and a mold base forming a cavity to be filled with resin comprises at least a part made of a heat insulating material, the part being adjacent to the surface processed layer.

According to the first and second aspects of the present invention, the mold base may be wholly made of a heat insulating material, or alternatively, a heat insulator may be provided between the mold base and the surface processed layer. The heat insulating material and the heat insulator are, for example, stainless steel, titanium alloy, nickel alloy, ceramic or heat resistance resin.

According to the first and second aspects of the present invention, since a heat insulating layer is provided between the core base and the surface processed layer, the temperature of resin injected into the cavity can be kept well, and the transfer accuracy of especially a fine configuration formed on the surface processed layer is improved. Further, since the part of a mold base which is adjacent to the surface processed layer is made of a heat insulating material, heat radiation from resin around the fine configuration is inhibited, and the transfer accuracy of the fine configuration is further improved.

### BRIEF DESCRIPTION OF THE DRAWINGS

This and other objects and features of the present invention will be apparent from the following description with reference to the accompanying drawings, in which:

FIG. 1 is a sectional view of a mold according to a first embodiment of the present invention;

FIG. 2 is a sectional view of a mold according to a second embodiment of the present invention;

FIG. 3 is a sectional view of a mold according to a third embodiment of the present invention;

FIG. 4 is a sectional view of a mold according to a fourth embodiment of the present invention;

FIG. 5 is a sectional view of a mold according to a fifth embodiment of the present invention;

FIG. 6 is a sectional view of a mold according to a sixth embodiment of the present invention; and

FIG. 7 is a sectional view of a conventional injection mold.

### DETAILED DESCRIPTION OF THE PREFERRED EMBODIMENTS

Preferred embodiments of an injection mold and an optical element molding method according to the present invention are hereinafter described with reference to the accompanying drawings. In the drawings showing the respective embodiments, the same parts/members are denoted by the same reference numbers, and repetitious descriptions are avoided.

### First Embodiment; See FIG. 1

FIG. 1 shows a mold 1A according to a first embodiment of the present invention. The mold 1A comprises a movable mold 10 and a fixed mold 20. The movable mold 10 comprises bases 11 and 12, a heat insulating layer 13 and a surface processed layer 14. The fixed mold 20 comprises a base 21.

The surface processed layer 14 is finished in accordance with the configuration of an optical surface of a product (optical element), such as a lens, a mirror, a prism plate, an optical waveguide, etc., and a fine configuration 14a, such as a diffraction grating, a prism surface, a blaze surface, etc., is formed. A cavity 30 is formed of the surface processed layer 14 and internal surfaces of the bases 21 and 11.

The bases 12 and 21 are made of a material usually used for mold bases, such as metal, for example, carbon steel, stainless steel or the like. The coefficient of thermal conductivity of carbon steel is 50 W/mK, and the coefficient of thermal conductivity of martensite stainless steel is 27 W/mK.

On the other hand, the base 11 is made of a heat insulating material. Here, for the base 11, various materials with lower coefficients of thermal conductivity than that of the material of the bases 12 and 21 are usable. For example, ferrite stainless steel (with a coefficient of thermal conductivity of 17 W/mK), austenitic stainless steel (with a coefficient of thermal conductivity of 13 W/mK), titanium alloy (Ti-6A1-4V with a coefficient of thermal conductivity of 7.5 W/mK), nickel alloy (inconel with a coefficient of thermal conductivity of 15 W/mK), etc. are usable.

The heat insulating layer 13 is, for example, of ceramic flame-coated on the core base 12, an organic material (heat resistant polymer) such as polyimide resin, sintered ceramic, which has a low coefficient of thermal conductivity, titanium alloy (Ti-6A1-4V, Ti-3A1-2.5V, Ti-6A1-7Nb, etc.), cermet (aluminum titanate, TiO₂—Al₂O₃), stainless steel (ferrite, austenitic, etc.), nickel alloy (inconel, FeNi), etc. The ceramic may be zirconia, silicon nitride, titanium nitride, etc. The surface processed layer 14 is a non-ferrous metal plating, such as a nickel plating, on the heat insulating layer 13.

The heat insulating layer 13 is not necessarily made of one of the above materials, and can be made of any material as long as the material has a lower coefficient of thermal conductivity than that of the core base 12. For example, a material with a coefficient of thermal conductivity which is, for example, lower than 20 W/mK can be used.

According to the first embodiment, since the heat insulating layer 13 exists between the core base 12 and the surface processed layer 14, the temperature of resin injected into the cavity 30 is kept well. Thereby, the transfer accuracy of especially the fine configuration 14a formed on the surface processed layer 14 is improved.

The mold base 11, which is a wall of the cavity 30, has a part 11a adjacent to the surface processed layer 14. Since the mold base 11 is wholly made of a heat insulating material, heat radiation from the resin at the part 11a adjacent to the fine configuration 14a is small. Therefore, the transfer accuracy of the fine configuration 14a is further improved.

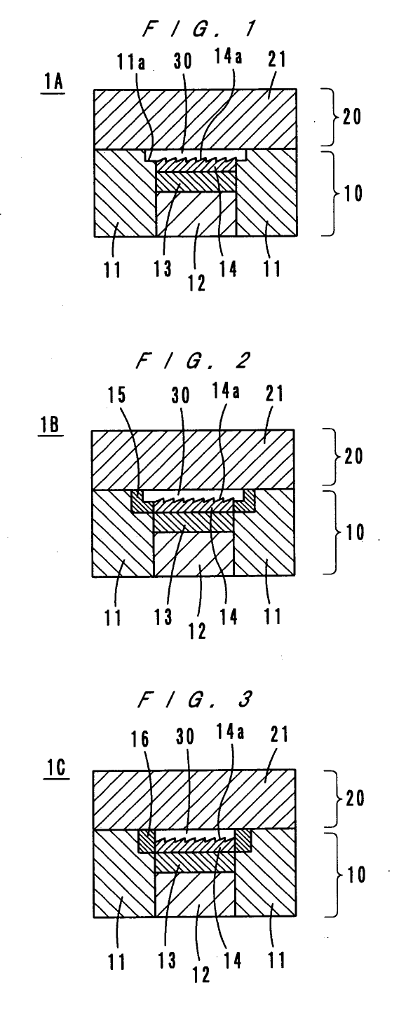

### Second Embodiment; See FIG. 2

FIG. 2 shows a mold 1B according to a second embodiment of the present invention. According to the second embodiment, a ring-type heat insulator 15 is provided on the inner circumferential surface of the base 11 which is a wall of the cavity 30, that is, between the surface processed layer 14 and the base 11.

In the mold 1B, the base 11 is made of a usual mold base material. The heat insulator 15 can be made of various materials with low coefficients of thermal conductivity, such as stainless steel, titanium alloy, nickel alloy, etc. Alternatively, ceramic, such as silicon nitride (Si3N4 with a coefficient of thermal conductivity of 20 W/m·K), alminium titanium (Al₂O₃—TiO₂ with a coefficient of thermal conductivity of 1.2 W/mK), etc., is usable for the heat insulator 15. Also, heat resistant polymer, such as polyimide resin (with a coefficient of thermal conductivity of 0.28 W/mK), etc. is usable. Further, other materials can be used, and ceramic of various formulas can be used. The other parts of the mold 1B are of the same structures and the same materials as those of the mold 1A according to the first embodiment.

According to the second embodiment, since the heat insulating layer 13 exists between the core base 12 and the surface processed layer 14, the temperature of resin injected into the cavity 30 can be kept well. Therefore, the transfer accuracy of especially the fine configuration 14a formed on the surface processed layer 14 is improved.

Further, since the heat insulator 15 exists between the surface processed layer 14 and the mold base 11 which is a wall of the cavity 30, heat radiation from the resin at the part adjacent to the fine configuration 14a is small, and the transfer accuracy of the fine configuration 14a is further improved.

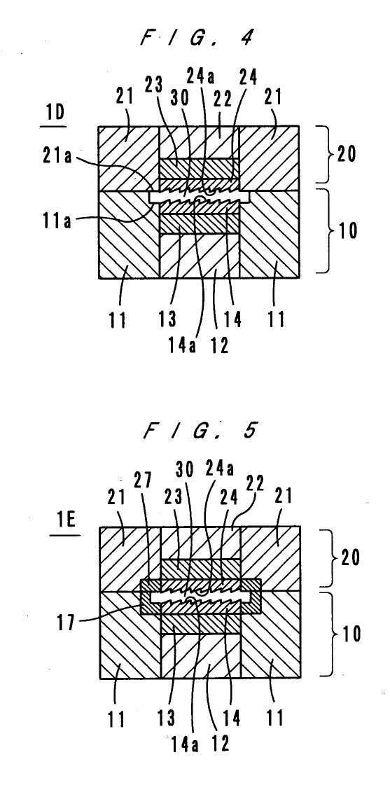

### Third Embodiment; See FIG. 3

FIG. 3 shows a mold 1C according to a third embodiment of the present invention. The mold 1C comprises a heat insulator 16 instead of the heat insulator 15 provided for the mold 1B according to the second embodiment. The materials usable for the heat insulator 15 can be also used for the heat insulator 16. The other parts of the mold 1C are of the same structures and of the same materials as those of the mold 1B according to the second embodiment, and therefore, the effect of the third embodiment has the same effect as the second embodiment.

### Fourth Embodiment; See FIG. 4

FIG. 4 shows a mold 1D according to a fourth embodiment of the present invention. As FIG. 4 shows, as well as the movable mold 10, the fixed mold 20 comprises bases 21 and 22, a heat insulating layer 23 and a surface processed layer 24. The surface processed layer 24, like the surface processed layer 14, is finished in accordance with the configuration of an optical surface of a product (an optical element), and a fine configuration 24a is formed.

The heat insulating layer 23 and the surface processed layer 24 are made of the materials used for the heat insulating layer 13 and the surface processed layer 14, which have been described in connection with the first embodiment. The bases 11 and 21 are made of a heat insulating material. The heat insulating material has been specifically described as the material of the base 11 in connection with the first embodiment. The core bases 12 and 22 are made of the material which has been described as the material of the base 12 in connection with the first embodiment.

According to the fourth embodiment, since the heat insulating layers 13 and 23 are provided respectively between the core base 12 and 14 and the surface processed layer 14 and between the core base 22 and the surface processed layer 24, the temperature of resin injected into the cavity 30 can be kept well. Therefore, the transfer accuracy of especially the fine configurations 14a and 24a formed on the surface processed layers 14 and 24 is improved.

The bases 11 and 21 form walls of the cavity 30 and have areas 11a and 21a, which are respectively adjacent to the surface processed layers 14 and 24. Since the bases 11 and 21 are wholly made of a heat insulating material, heat radiation from the resin at the areas 11a and 21a respectively adjacent to the fine configurations 14a and 24a is small, and the transfer accuracy of the fine configurations 14a and 24a is further improved. Additionally, the resin is heat-insulated both on the upper and lower surfaces, and there is no fear that the molded product may have a bend.

### Fifth Embodiment; See FIG. 5

FIG. 5 shows a mold 1E according to a fifth embodiment of the present invention. The mold 1E has ring-type heat insulators 17 and 27 on the inner circumferential surfaces of the bases 11 and 21 which are walls of the cavity 30. The heat insulators 17 and 27 are made of the material which has been described as the material of the heat insulator 15 in connection with the second embodiment.

The bases 11 and 21 are made of a usual mold base material. The other parts of the mold 1E are of the same structures and of the same materials as those of the mold iD according to the fourth embodiment. The fifth embodiment has the same effect as the fourth embodiment.

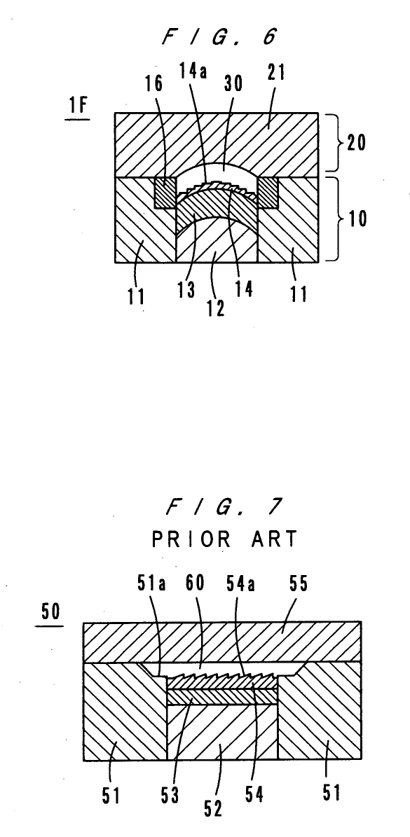

### Sixth Embodiment; See FIG. 6

FIG. 6 shows a mold 1F according to a sixth embodiment of the present invention. The mold 1F is to mold a curved lens. The mold 1F is composed of the same parts as the mold 1C according to the third embodiment, and these parts are made of the same materials as those of the mold 1C. Therefore, the sixth embodiment has the same effect as the third embodiment.

### Molding Method

An injection molding method by use of one of the molds 1A through 1F is briefly described.

First, melted resin at a specified temperature (for example, amorphous polyolefine resin) is injected into the cavity 30, and on completion of the injection, a pressure retention step starts immediately. The pressure retention step is a step of keeping a specified pressure applied to the resin so as to supply more resin to compensate shrinkage of the resin injected into the cavity 30 due to a fall in temperature. After the pressure retention step, a cooling (natural cooling) step starts. When at least the surface of the resin (molded product) cools down under a temperature to cause thermal deformation, the mold is opened, and the molded product is picked out of the mold by use of an eject pin or the like.

In the cavity 30, immediately after completion of the resin injection, the temperature of the resin starts falling. In the molds 1A through 1E, however, the heat insulating layers 13 and 23 exist in the rear of the fine configurations 14a and 24a, and the temperature of the resin injected into the cavity 30 can be kept. Also, the bases forming the cavity 30 are at least partly made of a heat insulating material, and heat radiation from the resin is inhibited. Therefore, the transfer accuracy of the fine configurations 14a and 24a is improved.

### Other Embodiments

An injection mold and an optical element injection molding method according to the present invention are not limited to the above-described embodiment.

The details of the mold can be arbitrarily structured, and the materials named in the above embodiments are merely examples. In FIGS. 1 through 6, the mold 10 may be a fixed mold, and the mold 20 may be a movable mold. Alternatively, the mold may be a three-plate type further having an intermediate mold.

Although the present invention has been described in connection with the preferred embodiments above, it is to be noted that various changes and modifications are possible to those who are skilled in the art. Such changes and modifications are to be understood as being within the scope of the present invention.

1. An injection mold for molding an optical element out of resin, comprising:
a heat insulating layer provided between a core base and a surface processed layer;
wherein, a mold base forming a cavity to be filled with resin comprises at least a part made of a heat insulating material, the part being adjacent to the surface processed layer.

2. An injection mold according to claim 1, wherein the mold base is wholly made of a heat insulating material.

3. An injection mold according to claim 1, wherein a heat insulator is provided between the mold base and the surface processed layer.

4. An injection mold according to claim 1, wherein the heat insulator is made of a material with a coefficient of thermal conductivity of not more than 20 W/mK.

5. An injection mold according to claim 1, wherein the heat insulating material is stainless steel, titanium alloy, nickel alloy, ceramic or heat resistant polymer.

6. A method for injection molding an optical element out of resin by use of an injection mold comprising at least a movable mold and a fixed mold, wherein:
the injection mold comprises a heat insulating layer between a core base and a surface processed layer; and
a mold base forming a cavity to be filled with resin comprises at least a part made of a heat insulating material, the part being adjacent to the surface processed layer.
